(19) United States
(12) Patent Application Publication
(10) Pub. No.: US 2025/0029602 A1
(43) Pub. Date: Jan. 23, 2025

(54) APPARATUS FOR VOICE RECOGNITION AND METHOD THEREOF

(71) Applicants: Hyundai Motor Company, Seoul (KR); Kia Corporation, Seoul (KR)

(72) Inventor: Sung Soo Park, Seoul (KR)

(21) Appl. No.: 18/512,252

(22) Filed: Nov. 17, 2023

(30) Foreign Application Priority Data
Jul. 21, 2023 (KR) 10-2023-0095497

(51) Int. Cl. G10L 15/18

(52) U.S. Cl. CPC G10L 15/1815

(57) ABSTRACT

In embodiments, a voice recognition apparatus, and a method thereof, includes a microphone that extracts an utterance of a user, a memory that stores a scenario matching intent extracted from the utterance, and a processor that searches for the scenario based on the utterance and performs a voice recognition function. The processor can extract a first intent from a first utterance and extract a second intent from a second utterance. The processor can separate the first intent and the second intent into partial intent units by using separators, and generate a final intent by combining partial intents of the first intent and the second intent such that duplicate partial intents are deleted depending on definitions of the separators.

### CROSS-REFERENCE TO RELATED APPLICATIONS

This application claims the benefit of Korean Patent Application No. 10-2023-0095497, filed on Jul. 21, 2023, which application is hereby incorporated herein by reference.

### TECHNICAL FIELD

The present disclosure relates to a voice recognition apparatus and a method thereof.

### BACKGROUND

A voice recognition apparatus refers to a system capable of identifying user intent included in a user's utterance and providing a service corresponding to the identified user intent. The voice recognition apparatus controls the corresponding device in conjunction with a specific device depending on the user intent and provides specific information depending on the user intent.

The voice recognition apparatus is widely used due to the convenience of a user input. For example, with the development of automotive industries, a system, which automatically performs an action satisfying the user intent by using voice recognition within a vehicle, is continuously being developed to provide convenience to a driver. Services that utilize voice recognition are provided in various devices such as a smartphone and an artificial intelligence (AI) speaker as well as a vehicle. For example, various service providers such as Apple's Siri, Amazon's Alexa, KT's Genie, SK's NUGU, and the like, provide voice recognition services.

The voice recognition apparatus may improve voice recognition by using AI. However, when a user's utterance is implied, it may be difficult for the voice recognition apparatus to clearly determine the intent corresponding to the utterance.

To recognize a wide range of utterances, it is necessary to define scenarios that match as many utterances as possible. In this case, the number of cases is too large, thereby increasing memory capacity.

### SUMMARY

The present disclosure relates to a voice recognition apparatus and a method thereof, and more particularly, relates to a technology for clearly determining user intent.

The present disclosure has been made to solve the above-mentioned problems occurring in the prior art while advantages achieved by the prior art are maintained intact.

An embodiment of the present disclosure provides a voice recognition apparatus capable of clearly determining a user utterance, and a method embodiment thereof.

An embodiment of the present disclosure provides a voice recognition apparatus that is capable of performing voice recognition based on various user utterances while reducing memory capacity, and a method embodiment thereof.

Technical problems to be solved by an embodiment of the present disclosure are not necessarily limited to the aforementioned problems, and any other technical problems not mentioned herein can be clearly understood from the following description by those skilled in the art to which the present disclosure pertains.

According to an embodiment of the present disclosure, a voice recognition apparatus includes a microphone that extracts an utterance of a user, a memory that stores a scenario matching intent extracted from the utterance, and a processor that searches for the scenario based on the utterance, and performs a voice recognition function. The processor can extract a first intent from a first utterance and extract a second intent from a second utterance, separate the first intent and the second intent into partial intent units by using predetermined separators, and generate a final intent by combining partial intents of each of the first intent and the second intent such that duplicate partial intents are deleted depending on definition of the separators.

According to an embodiment, the processor may generate the final intent based on the first utterance and the second utterance when an action, a target, an entity, or any combination thereof, is missing from the second utterance obtained after the first utterance.

According to an embodiment, the processor may assign one separator among the separators to an action, a target, and entities included in each of the first intent and the second intent.

According to an embodiment, the processor may assign a first separator to first partial intent, which points to the action or the target, from among first partial intents extracted from the first intent, and may assign a second separator to second partial intent pointing to the action or the target, which is opposite to the partial intent to which the first separator is assigned, from among second partial intents extracted from the second intent.

According to an embodiment, the processor may generate the final intent by deleting the first partial intent and the second partial intent, which are the same as each other, when the first partial intent to which the first separator is assigned is the same as the second partial intent to which the second separator is assigned.

According to an embodiment, the processor may assign a third separator to an entity among the first partial intents, and may assign a fourth separator to partial intent, which negates the entity to which the third separator is assigned, from among the second partial intents.

According to an embodiment, the processor may generate the final intent by deleting the entities that are the same as each other, when the entity to which the third separator is assigned is the same as the entity to which the fourth separator is assigned.

According to an embodiment, the processor may generate the final intent by arranging the first intent and the second intent in a reverse order of utterances.

According to an embodiment, the processor may generate the final intent by deleting actions other than the most preceding action among the partial intents.

According to an embodiment, the processor may generate the final intent by deleting partial intents, which match the deleted partial intents, from among the partial intents.

According to an embodiment of the present disclosure, a voice recognizing method includes extracting a first intent from a first utterance and extracting a second intent from a second utterance, separating the first intent and the second intent into partial intent units by using predetermined separators, generating a final intent by combining partial intents of each of the first intent and the second intent such that duplicate partial intents are deleted depending on definitions of the separators, and performing a voice recognition function based on a scenario matching the final intent.

According to an embodiment, the extracting of the second intent from the second utterance may be performed after the first intent is extracted.

According to an embodiment, the separating of the first intent and the second intent into the partial intent units may include assigning one separator among the separators to an action, a target, and entities, included in each of the first intent and the second intent.

According to an embodiment, the separating of the first intent and the second intent into the partial intent units may include assigning a first separator to a first partial intent, which points to the action or the target, from among first partial intents extracted from the first intent, and assigning a second separator to a second partial intent pointing to the action or the target, which is opposite to the partial intent to which the first separator is assigned, from among the second partial intents extracted from the second intent.

According to an embodiment, the generating of the final intent may include deleting the first partial intent and the second partial intent, which are the same as each other, when the first partial intent to which the first separator is assigned is the same as the second partial intent to which the second separator is assigned.

According to an embodiment, the separating of the first intent and the second intent into the partial intent units may include assigning a third separator to an entity among the first partial intents, and assigning a fourth separator to the partial intent, which negates the entity to which the third separator is assigned, from among the second partial intents.

According to an embodiment, the generating of the final intent may include deleting the entities that are the same as each other, when the entity to which the third separator is assigned is the same as the entity to which the fourth separator is assigned.

According to an embodiment, the generating of the final intent may further include arranging the first intent and the second intent in a reverse order of utterances.

According to an embodiment, the generating of the final intent may further include deleting actions other than the most preceding action among the partial intents.

According to an embodiment, the generating of the final intent may further include deleting partial intents, which match the deleted partial intents, from among the partial intents.

### BRIEF DESCRIPTION OF THE DRAWINGS

The above and other features and advantages of the present disclosure can be more apparent from the following detailed description taken in conjunction with the accompanying drawings, in which:

FIG. 1 is a block diagram illustrating a configuration of a voice recognition apparatus, according to an embodiment of the present disclosure;

FIG. 2 is a diagram illustrating an internal configuration of a vehicle equipped with a voice recognition apparatus, according to an embodiment of the present disclosure;

FIG. 3 is a flowchart illustrating a voice recognizing method, according to an embodiment of the present disclosure;

FIG. 4 is a diagram for describing an intent extracting process, according to an embodiment of the present disclosure;

FIG. 5 is a diagram for describing a rearrangement process of user intent, according to an embodiment of the present disclosure;

FIG. 6 is a diagram for describing a method of generating final intent, according to an embodiment of the present disclosure;

FIG. 7 is a diagram for describing a method of generating final intent, according to an embodiment of the present disclosure;

FIG. 8 is a diagram for describing a method of generating final intent, according to an embodiment of the present disclosure; and

FIG. 9 is a block diagram illustrating a computing system, according to an embodiment of the present disclosure.

### DETAILED DESCRIPTION OF ILLUSTRATIVE EMBODIMENTS

Hereinafter, some embodiments of the present disclosure will be described in detail with reference to the accompanying drawings. In adding reference numerals to components of each drawing, it should be noted that the same components have the same reference numerals, although they are indicated on another drawing. Furthermore, in describing the embodiments of the present disclosure, detailed descriptions associated with well-known functions or configurations will be omitted when they may make subject matters of the present disclosure unnecessarily obscure.

In describing elements of an embodiment of the present disclosure, the terms “first,” “second,” “A,” “B,” “(a),” “(b),” and the like, may be used herein. These terms can be merely used to distinguish one element from another element, but do not necessarily limit the corresponding elements irrespective of the nature, order, or priority of the corresponding elements. Furthermore, unless otherwise defined, all terms including technical and scientific terms used herein can be interpreted as is customary in the art to which the present disclosure pertains. It can be understood that terms used herein can be interpreted as having a meaning that is consistent with their meaning in the context of the present disclosure and the relevant art and will not be interpreted in an idealized or overly formal sense unless expressly so defined herein.

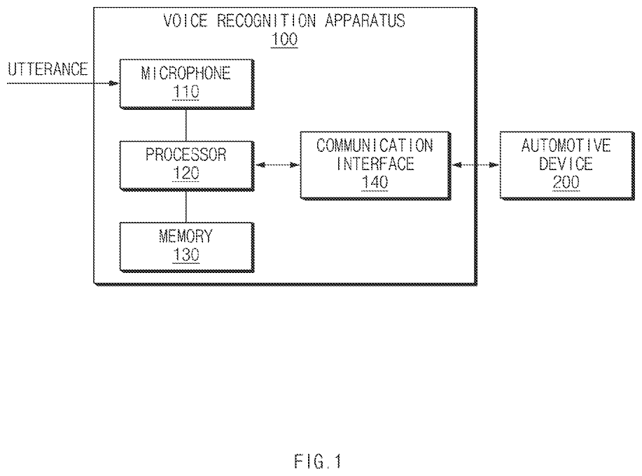

Hereinafter, various embodiments of the present disclosure will be described in detail with reference to FIGS. 1 to 9.

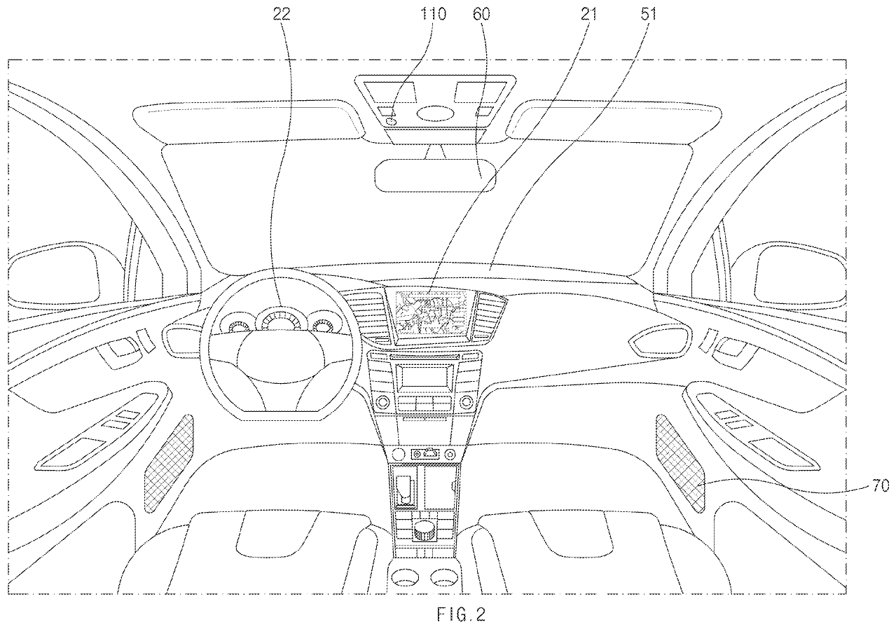

FIG. 1 is a block diagram illustrating a configuration of a voice recognition apparatus, according to an embodiment of the present disclosure. FIG. 2 is a diagram illustrating an internal configuration of a vehicle equipped with a voice recognition apparatus, according to an embodiment of the present disclosure. An embodiment in which a voice recognition apparatus is mounted on a vehicle will be mainly described, but the voice recognition apparatus may be applied to any system for a voice recognition function.

Referring to FIGS. 1 and 2, a voice recognition apparatus according to an embodiment of the present disclosure may include a microphone 110, a processor 120, and a memory 130.

The microphone 110 may receive a voice signal, and may be positioned at a location at which it is easy to receive the voice of a user in a vehicle. For example, the microphone 110 may be positioned around a ceiling of the vehicle where a room mirror 60 is located, and a location of the microphone 110 may not be limited thereto.

The processor 120 may perform a voice recognition function based on a user voice obtained by the microphone 110.

The processor 120 may extract a first intent from a first utterance and may extract a second intent from a second utterance. The first utterance and the second utterance may be utterances obtained from the user through the microphone 110. The second utterance may be performed after the first intent for the first utterance is extracted. For example, the second utterance may refer to an utterance obtained after a voice recognition function is performed on the first utterance.

The processor 120 may separate the first intent and the second intent into partial intent units by using preset/selected/predetermined separators. The partial intent unit may be a part of speech or a word. Furthermore, the processor 120 may separate the first intent and the second intent by positioning a separator to precede partial intents. Two or more separators may be included, and each of the separators may separate targets and/or actions, which are opposite to each other. For example, a first separator may be assigned to a partial intent indicating an operation for a radio, and a second separator may be assigned to a partial intent for stopping the operation for the radio. A specific embodiment thereof will be described later.

The processor 120 may generate a final intent by deleting duplicate partial intents depending on the definition(s) of separators. The duplicate partial intents may be partial intents extracted from different intents. For example, one of a pair of duplicate partial intents may be extracted from the first intent, and the other thereof may be extracted from the second intent. When the duplicate partial intents are matched with separators opposite to each other, the processor 120 may delete all the duplicate partial intents. For example, when there is navigation, to which the first separator is assigned, and navigation, to which the second separator is assigned, the navigation may be deleted from the final intent (because the first and second separators are opposite).

The processor 120 may perform a voice recognition function based on a scenario matching the final intent.

In addition, when an action, a target, an entity, or any combination thereof, is missing from the second utterance, the processor 120 may generate the final intent based on the first utterance and the second utterance.

The processor 120 may perform AI training on utterance data obtained by the microphone 110 to perform the voice recognition function. To this end, the processor 120 may include an artificial intelligence (hereinafter referred to as an “AI”) processor. The AI processor may train a neural network by using a pre-stored program. The neural network for detecting a target vehicle and a dangerous vehicle may be designed to simulate a human brain structure on a computer, and may include a plurality of network nodes, each of which has a weight and which simulate neurons of a human neural network. The plurality of network nodes may exchange data depending on each connection relationship such that neurons simulate synaptic activity of neurons that exchange signals through synapses. The neural network may include a deep learning model developed from a neural network model. In the deep learning model, a plurality of network nodes may exchange data depending on a convolution connection relationship while being located on different layers. Examples of neural network models may include various deep learning techniques such as deep neural networks (DNN), convolutional neural networks (CNN), recurrent neural networks (RNN) restricted Boltzmann machine (RBM), deep belief networks (DBN), and deep Q-networks.

Also, the processor 120 may control automotive devices 200 mounted inside a vehicle through a communication interface 140.

The memory 130 may store a scenario matching intent extracted based on an utterance. Moreover, the memory 130 may store an algorithm for an operation of the processor 120 and the AI processor. The memory 130 may use a hard disk drive, a flash memory, an electrically erasable programmable read-only memory (EEPROM), a static random access memory (SRAM), a ferro-electric RAM (FRAM), a phase-change RAM (PRAM), a magnetic RAM (MRAM), a dynamic RAM (DRAM), a synchronous DRAM (SDRAM), a double date rate-SDRAM (DDR-SDRAM), and the like, or any combination thereof.

The automotive device 200 may be controlled based on voice recognition and may include an audio-visual-navigation (AVN) device mounted on a dashboard 51. The AVN device may include an audio or navigation device, and may include an AVN display 21 that displays an operating state while receiving a user input in addition to voice recognition.

A cluster display 22 displaying a vehicle status or driving-related information may be positioned in an area of the dashboard 51 close to a driver's seat.

Furthermore, a speaker 70 for assisting a voice recognition procedure by outputting a voice in a form of a conversation with a user while the voice recognition function is being performed may be positioned inside a vehicle.

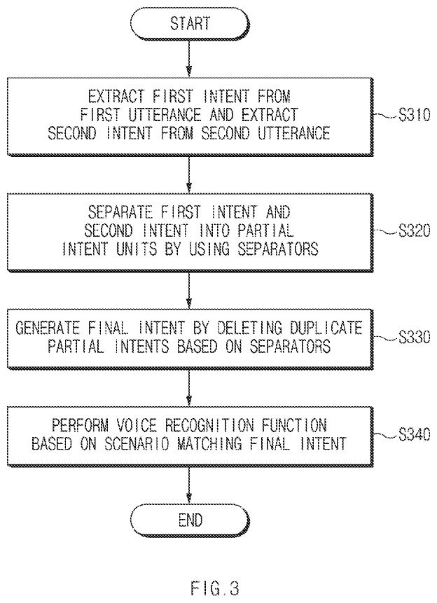

FIG. 3 is a flowchart illustrating a voice recognizing method, according to an embodiment of the present disclosure. A procedure shown in FIG. 3 may be controlled by the processor shown in FIG. 1.

Referring to FIG. 3, a voice recognizing method according to an embodiment of the present disclosure will be described as follows.

In operation S310, the processor 120 may extract a first intent from a first utterance and may extract a second intent from a second utterance.

The second utterance may be obtained after the first intent for the first utterance is extracted.

In operation S320, the processor 120 may separate the first intent and the second intent into partial intent units by using preset/selected/predetermined separators.

The partial intent unit may be an action, a target, or an entity included in the intent.

The processor 120 may separate the first intent and the second intent into partial intent units by assigning one separator to actions, targets, and entities included in the first intent and the second intent.

The actions and targets in the first intent and second intent may be identified by a first separator and a second separator. The first separator may be assigned to actions and targets of the first intent and the second intent. The second separator may be assigned to actions and targets, which overlap those extracted from the first intent and which include negative meanings, from among the actions and targets of the second intent.

Entities in the first intent and the second intent may be identified by a third separator and a fourth separator. The processor 120 may assign the third separator to an entity among first partial intents. Furthermore, the processor 120 may assign the fourth separator to a partial intent that negates an entity, to which the third separator is assigned, from among second partial intents.

In operation S330, the processor 120 may generate a final intent by deleting duplicate partial intents depending on the definition of separators.

When separators opposite to each other are assigned to the duplicate partial intents, the processor 120 may remove the duplicate partial intents. According to an embodiment, the first separator and the second separator may be opposite to each other, and the third separator and fourth separator may be opposite to each other.

In addition, the processor 120 may obtain the final intent by arranging the first intent and the second intent in the reverse order of timing at which an utterance is obtained.

Also, in a process of generating the final intent, the processor 120 may delete actions other than the most preceding action among partial intents.

Moreover, in the process of generating the final intent, the processor 120 may delete partial intents that match the deleted partial intents from among the partial intents.

In operation S340, the processor 120 may perform a voice recognition function based on a scenario matching the final intent.

Hereinafter, a specific embodiment of each procedure will be described.

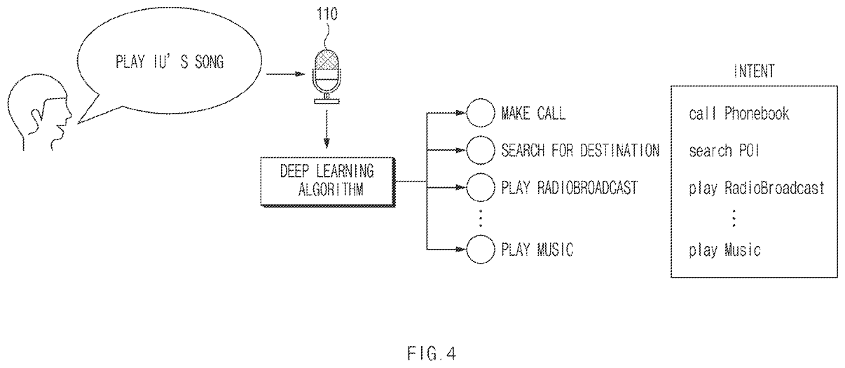

FIG. 4 is a diagram for describing an intent extracting process, according to an embodiment of the present disclosure. Referring to FIGS. 1 and 4, the intent extracting process is as follows.

The microphone 110 may receive a user's utterance, and the processor 120 may extract the user's intent by using a deep learning algorithm. For example, the processor 120 may convert a user utterance into an utterance text and may determine user intent corresponding to the utterance text.

To convert the user utterance into the utterance text, the processor 120 may use a speech to text (STT) engine. The processor 120 may extract a feature vector from the user utterance and may obtain the utterance text by using the extracted feature vector and the trained reference pattern.

To determine the user intent included in the utterance text, the processor 120 may use a natural language understanding (NLU) technology. The processor 120 may include an NLU engine that determines the user intent by applying the NLU technology to an input sentence.

The processor 120 may perform NLU as follows.

The processor 120 may recognize a named entity from the utterance text. The named entity can be a proper noun such as a person's name, place name, organization name, time, date, currency, or the like. Named entity recognition refers to a task of identifying the named entity in a sentence and determining the type of the named entity identified. The meaning of the sentence may be grasped by extracting important keywords from a sentence through the named entity recognition.

The processor 120 may determine a domain from the utterance text. A domain may identify the subject of a user utterance. For example, domains representing various subjects, such as control of electronic devices, schedule management, provision of information on weather or traffic conditions, sending messages, making phone calls, navigation, and vehicle control, may be determined based on the utterance text.

The processor 120 may analyze the speech act of the utterance text. Speech act analysis refers to a task of analyzing the intent of the utterance, and is used to determine the intent of the utterance, such as whether a user is asking a question, making a request, responding, or simply expressing emotion.

The processor 120 may determine intent and an entity required to perform the intent based on information such as a domain, a named entity, and a speech act extracted from the utterance text.

For example, when the utterance text is “turn on the air conditioner”, the domain may be [vehicle control], the intent may be [turn on, air conditioner], and the entity required to control the air conditioner may be [temperature, wind volume].

Alternatively, when the utterance text is “send a message”, the domain may be [sending/receiving messages], the intent may be [send, message], and the entity required to send and receive messages may be [recipient, content].

The intent may be determined by the action and the target. The action may indicate an operation of the domain, and the target may mean a subject or object of the action. For example, the action becomes “turn on”, and the target becomes “air conditioner”. The action may be referred to as an “operator”, and the target may be referred to as an “object”.

Through this process, the processor 120 may extract various intents from the user utterance, and may extract user intents such as [call Phonebook], [search POI], [play radiobroadcast], and [play music].

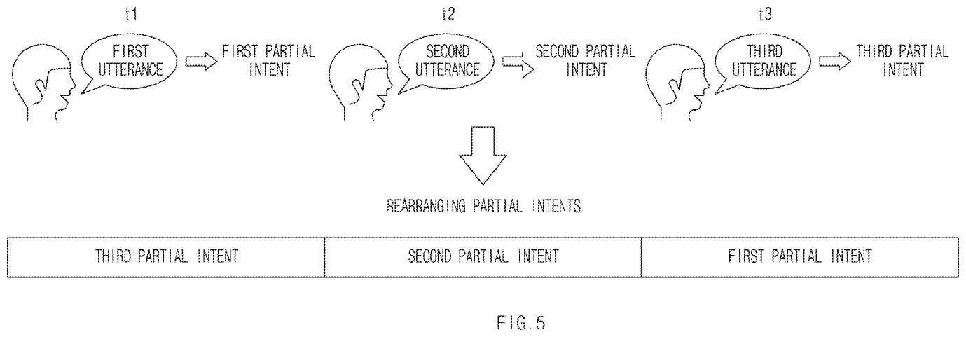

FIG. 5 is a diagram for describing a rearrangement process of user intent, according to an embodiment of the present disclosure.

Referring to FIG. 5, the processor 120 may extract partial intents based on a plurality of utterances and may rearrange the partial intents. The process of rearranging partial intents may be understood as an intermediate process of generating final intents.

The processor 120 may distinguish utterances obtained at different timings. Each of the utterances may be classified based on a state where the intent is extracted from the utterance. For example, at first timing t1, the processor 120 may generate a first partial intent based on a first utterance. Afterward, at second timing t2, the processor 120 may generate a second partial intent based on a second utterance. Likewise, in third timing t3, the processor 120 may generate a third partial intent based on a third utterance.

The first partial intent may be obtained by separating a first intent, which is extracted based on the first utterance, by using a separator. Likewise, the second partial intent may be obtained by separating a second intent, which is extracted based on the second utterance, by using a separator. The third partial intent may be obtained by separating a third intent, which is extracted based on the third utterance, by using a separator.

The processor 120 may separate intent by assigning a separator to actions, targets, and entities. A process of assigning a separator may include a process of marking a separator prior to each action, target, or entity. The separator may be omitted from the first action, the first target, or the first entity in respective intents.

The separators may include first to fourth separators.

The first separator may be expressed as [+] and may be assigned to an action or target. For example, intents such as [call Phonebook], [search POI], [play radiobroadcast], and [play music] may be separated into, for example, [call+Phonebook], [search+POI], [play+radiobroadcast], [play+music] by using the first separator.

The second separator may be expressed as [-], and may be assigned to an action or target that negates the action or target to which the first separator is assigned. In detail, the second separator may be used in a process of negating the action or target to which the first separator is assigned in the preceding intent. For example, in the first utterance, a partial intent of [+Navi] may be generated depending on the intent of [destination search]. When the intent of [not route guidance] is extracted from the second utterance, the partial intent of [−Navi] may be generated.

A third separator may be expressed as [*] and may be assigned to an entity. For example, when an entity of a singer or title is tagged to intent for playing music, the processor 120 may generate partial intent such as *{singer} and *{title}.

A fourth separator may be expressed as [÷], and may be assigned to an entity that negates the entity to which the first separator is assigned. The fourth separator may be used in a process of negating an entity to which the second separator is assigned in the preceding intent. For example, when partial intent of *{singer1} is generated in the first utterance and intent of [not singer1] is extracted from the second utterance, the partial intent of ÷{singer1} may be generated.

Hereinafter, an example of generating a final intent based on utterances of a user is as follows.

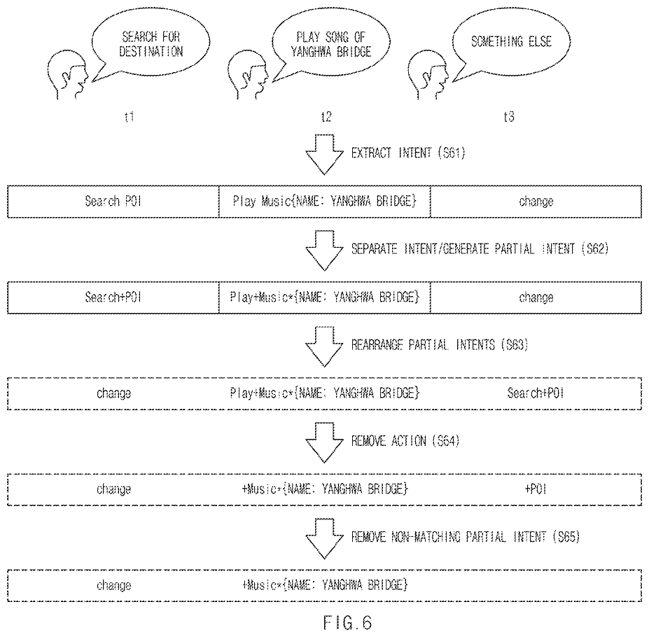

FIG. 6 is a diagram for describing a method of generating final intent, according to an embodiment of the present disclosure.

Referring to FIG. 6, in operation S61, the processor 120 may extract intent based on a first utterance at the first timing t1. Likewise, the processor 120 may extract a second intent based on a second utterance at the second timing t2, and may extract a third intent based on a third utterance at the third timing t3. For example, the processor 120 may extract the first intent of [search POI] based on the first utterance of “search for a destination”, and may extract the second intent of [Play Music {name: Yanghwa Bridge}] based on the second utterance of “play the song of Yanghwa Bridge.” Moreover, the processor 120 may extract the third intent of [change] based on the third utterance of “something else”.

In operation S62, the processor 120 may separate the first intent, the second intent, and the third intent by using separators. [search POI] may be separated into an action of “search” and a target of “POI”. The processor 120 may separate the first intent into [search+POI] by using a first separator. [Play Music {name: Yanghwa Bridge}] may be separated into an action of “Play”, a target of “Music”, and an entity of {name: Yanghwa Bridge}. The processor 120 may separate the second intent into [Play+Music*{name: Yanghwa Bridge}] by using the first separator and a third separator. Also, because [change] includes one action, the processor 120 may determine [change] as partial intent. In [search+POI], each of “search” and “POI” may be referred to as “first partial intent”. In [Play+Music*{name: Yanghwa Bridge}], each of “Play Music” and {name: Yanghwa Bridge} may be referred to as “second partial intent”. In [change], “change” may be referred to as “third partial intent”.

In operation S63, the processor 120 may rearrange partial intents. The processor 120 may arrange partial intents in the reverse order of utterances. For example, the processor 120 may place first partial intents, which are obtained first, in the last order, and may place third partial intents, which are obtained last, in the first order.

In operation S64, the processor 120 may remove other actions other than the most preceding action. For example, “Play” and “search” may be removed from [change Play Music {name: Yanghwa Bridge} search+POI] while only “change” that is the most preceding action is kept.

In operation S65, the processor 120 may remove non-matching partial intent. For example, +POI may be interpreted as a target that matches an action of “search”, and the action of “search” may be removed after operation S64. When there is a target from which the action has been removed, the processor 120 may also remove the corresponding target.

As a result, the processor 120 may generate a final intent of [change+Music*{name: Yanghwa Bridge}].

As in an embodiment shown in FIG. 6, because an action or target in the third utterance of “something else” is unclear, a situation in which a voice recognition function is incapable of being accurately performed only with the third utterance may occur conventionally. According to an embodiment of the present disclosure, even when ambiguous utterances are obtained, the final intent capable of accurately reflecting a user's intent may be generated based on the previous utterances, and the voice recognition function may be accurately performed based on the final intent.

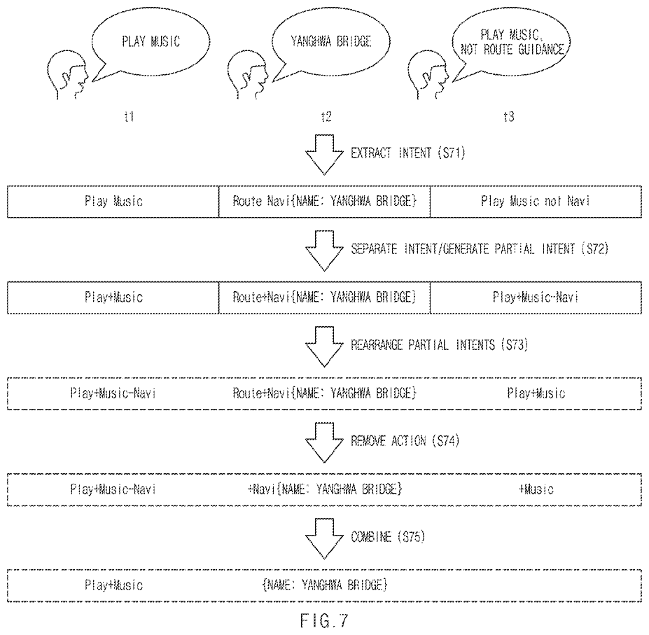

FIG. 7 is a diagram for describing a method of generating final intent, according to another embodiment of the present disclosure.

Referring to FIG. 7, in operation S71, the processor 120 may extract intent based on a first utterance at the first timing t1. Likewise, the processor 120 may extract a second intent based on a second utterance at the second timing t2, and may extract a third intent based on a third utterance at the third timing t3. For example, the processor 120 may extract the first intent of [Play Music] based on the first utterance of “play music”, and may extract the second intent of [Route Navi{name: Yanghwa Bridge}] based on the second utterance of “Yanghwa Bridge”. Moreover, the processor 120 may extract the third intent of [Play Music not Navi] based on the third utterance of “play music, not route guidance”.

In operation S72, the processor 120 may separate the first intent, the second intent, and the third intent by using separators.

Because [Play Music] includes an action of “Play” and a target of “Music”, the processor 120 may separate the first intent into [Play+Music].

Because [Route Navi{name: Yanghwa Bridge}] includes an action of “Route”, a target of “Navi”, and an entity of {name: Yanghwa Bridge}, the processor 120 may separate the second intent into [Route+Navi*{name: Yanghwa Bridge}].

[Play Music not Navi] may include an action of “Play”, a target of “Music”, and a target of “not Navi”. In the third intent, “not Navi” may negate “Navi”, which is the preceding second partial intent. As a result, the processor 120 may separate the third intent into [Play+Music−Navi].

In operation S73, the processor 120 may rearrange partial intents. The processor 120 may arrange partial intents in the reverse order of utterances. For example, the processor 120 may place first partial intents, which are obtained first, in the last order, and may place third partial intents, which are obtained last, in the first order.

In operation S74, the processor 120 may remove other actions, other than the most preceding action. For example, the processor 120 may remove “Route” of the second partial intent and “Play” of the first partial intent from [Play+Music−Navi Route+Navi{name: Yanghwa Bridge} Play Music], while only “Play” that is the most preceding action is kept.

In operation S75, the processor 120 may combine partial intents from which an action is removed, and may remove duplicate partial intents during the combining process. The duplicate partial intents may be identical partial intents marked with separators opposite to each other. The first separator and the second separator may be a couple of separators opposite to each other. The third separator and the fourth separator may be a couple of separators opposite to each other. For example, when partial intents that point to the same target, such as “−Navi” and “+Navi”, are separated by separators opposite to each other, the processor 120 may determine “−Navi” and “+Navi” as duplicate partial intents and may delete “−Navi” and “+Navi”.

As a result, the processor 120 may generate a final intent of [Play+Music*{name: Yanghwa Bridge}].

As illustrated in FIG. 7, because the action in the second utterance is omitted, it may be unclear to identify the intent. Furthermore, because the entity in the third utterance is omitted, it may be unclear to identify the intent.

According to an embodiment of the present disclosure, even when ambiguous utterances are obtained, the final intent capable of accurately reflecting a user's intent may be generated based on the previous utterances, and the voice recognition function may be accurately performed based on the final intent.

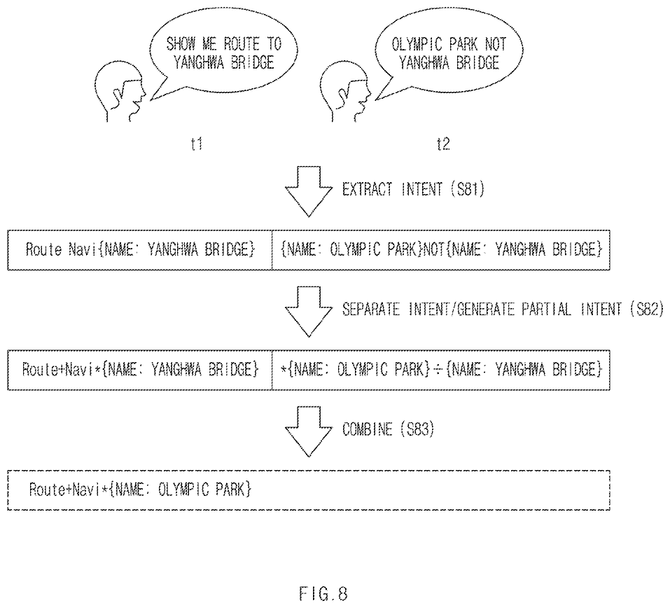

FIG. 8 is a diagram for describing a method of generating final intent, according to another embodiment of the present disclosure.

Referring to FIG. 8, in operation S81, the processor 120 may extract intent based on a first utterance at the first timing t1, and may extract a second intent based on a second utterance at the second timing t2. For example, the processor 120 may extract the first intent of [Route Navi{name: Yanghwa Bridge}] based on the first utterance of “show me a route to Yanghwa Bridge”, and may extract the second intent of [{name: Olympic Park} not {name: Yanghwa Bridge}] based on the second utterance of “Olympic Park not Yanghwa Bridge”.

In operation S82, the processor 120 may separate the first intent, the second intent, and the third intent by using separators.

Because [Route Navi{name: Yanghwa Bridge}] includes an action of “Route”, a target of “Navi”, and an entity of {name: Yanghwa Bridge}, the processor 120 may separate the first intent into [Route+Navi*{name: Yanghwa Bridge}].

Because [{name: Olympic Park} not {name: Yanghwa Bridge}] includes an entity of {name: Olympic Park} and an entity of not {name: Yanghwa Bridge}, the processor 120 may separate the second intent into [*{name: Olympic Park}: {name: Yanghwa Bridge}].

In operation S83, the processor 120 may combine partial intents from which an action is removed, and may remove duplicate partial intents during the combining process. For example, *{name: Yanghwa Bridge} is partial intent to which a third separator is assigned, and #{name: Yanghwa Bridge} is partial intent to which a fourth separator is assigned. Because the two entities are the same as each other and having opposite separators “*” and “÷,” the two entities may be deleted.

As a result, the processor 120 may generate a final intent of [Route+Navi*{name: Olympic Park}].

As in the embodiment shown in FIG. 8, even when user intent is not clear because the action of the second utterance is unclear, according to an embodiment of the present disclosure, the final intent capable of accurately reflecting the user intent may be generated.

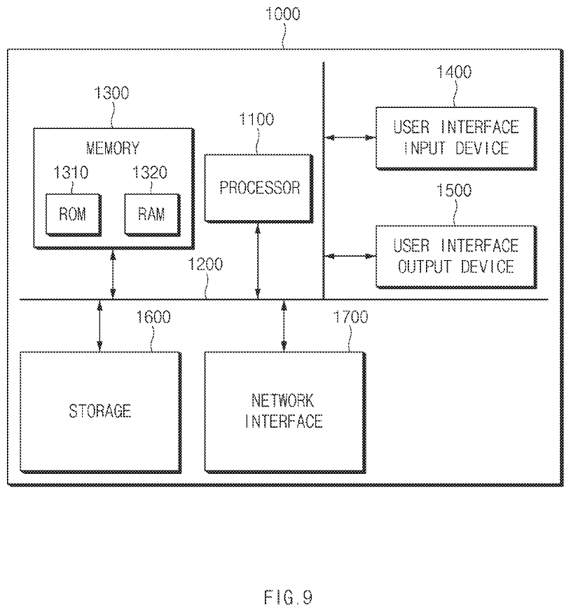

FIG. 9 illustrates a computing system, according to an embodiment of the present disclosure.

Referring to FIG. 9, a computing system 1000 may include at least one processor 1100, a memory 1300, a user interface input device 1400, a user interface output device 1500, a storage 1600, and a network interface 1700, which can be connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, operations of a method or algorithm described in connection with an embodiment disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, a compact disc-ROM (CD-ROM), or any combination thereof.

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of a technical idea of an embodiment of the present disclosure, and various modifications and modifications may be made by one skilled in the art without departing from the essential characteristic of the present disclosure.

Accordingly, embodiments of the present disclosure are intended not to limit but to explain technical ideas of the present disclosure, and the scope and spirit of the present disclosure is not necessarily limited by the above embodiments. The scope of protection of the present disclosure can be construed by the attached claims, and all equivalents thereof can be construed as being included within the scope of the present disclosure.

According to an embodiment of the present disclosure, even when a user utterance is unclear, clearer intent may be generated based on intent of previous utterances.

Moreover, according to an embodiment of the present disclosure, a voice recognition function may be performed in response to various user utterances while reducing the number of scenarios matching a user utterance.

A variety of effects directly or indirectly understood through the present disclosure may be provided.

Hereinabove, although the present disclosure has been described with reference to exemplary embodiments and the accompanying drawings, the present disclosure is not necessarily limited thereto, but may be variously modified and altered by those skilled in the art to which the present disclosure pertains without departing from the spirit and scope of the present disclosure claimed in the following claims.

What is claimed is:

1. A voice recognition apparatus comprising:
a microphone configured to extract an utterance of a user;
a memory configured to store a scenario matching intent extracted from the utterance; and
a processor configured to search for the scenario based on the utterance and to perform a voice recognition function, wherein the processor is configured to:
extract a first intent from a first utterance and extract a second intent from a second utterance,
separate the first intent and the second intent into partial intents by using separators, and
generate a final intent by combining partial intents of each of the first intent and the second intent, such that duplicate partial intents are deleted depending on definitions of the separators.

2. The apparatus of claim 1, wherein the processor is further configured to generate the final intent based on the first utterance and the second utterance in response to one of or any combination of an action, a target, or an entity, is missing from the second utterance obtained after the first utterance.

3. The apparatus of claim 1, wherein the processor is further configured to assign one separator among the separators to each one of or any combination of an action, a target, and an entity, included in each of the first intent and the second intent.

4. The apparatus of claim 3, wherein the processor is further configured to:
assign a first separator to first partial intents, wherein the first separator points to the action or the target included among the first partial intents extracted from the first intent; and
assign a second separator to second partial intents included among the second partial intents extracted from the second intent, wherein the second separator points to the action or the target being opposite to the first partial intents to which the first separator was assigned.

5. The apparatus of claim 4, wherein the processor is further configured to generate the final intent by deleting the first partial intent and the second partial intent that are the same as each other, in response to the first partial intent to which the first separator is assigned being the same as the second partial intent to which the second separator is assigned.

6. The apparatus of claim 4, wherein the processor is further configured to:
assign a third separator to an entity included among the first partial intents; and
assign a fourth separator to the entity included among the second partial intents, wherein the fourth separator negates the entity to which the third separator was assigned.

7. The apparatus of claim 6, wherein the processor is further configured to generate the final intent by deleting the entities that are the same as each other and to which the third separator is assigned is the same as the entity to which the fourth separator is assigned.

8. The apparatus of claim 1, wherein the processor is configured to generate the final intent by arranging the first intent and the second intent in a reverse order of utterances.

9. The apparatus of claim 8, wherein the processor is configured to generate the final intent by deleting actions other than a most preceding action among the partial intents.

10. The apparatus of claim 9, wherein the processor is configured to generate the final intent by deleting partial intents that match the deleted partial intents, from among the partial intents.

11. A voice recognizing method, the method comprising:
extracting a first intent from a first utterance;
extracting a second intent from a second utterance;
separating the first intent and the second intent into partial intent units by using separators;
generating a final intent by combining the partial intent units of each of the first intent and the second intent such that duplicate partial intent units are deleted based on definitions of the separators; and
performing a voice recognition function based on a scenario matching the final intent.

12. The method of claim 11, wherein the extracting of the second intent from the second utterance is performed after the extracting of the first intent.

13. The method of claim 11, wherein the separating of the first intent and the second intent into the partial intent units comprises assigning one separator among the separators to one of or any combination of an action, a target, and an entity, included in each of the first intent and the second intent.

14. The method of claim 13, wherein the separating of the first intent and the second intent into the partial intent units comprises:
assigning a first separator to a first partial intent included in the first intent, wherein the first separator points to the action or the target included in the first partial intent; and
assigning a second separator to a second partial intent included in the second intent, wherein the second separator points to the action or the target included in the second partial intent that is opposite to the first partial intent to which the first separator was assigned.

15. The method of claim 14, wherein the generating of the final intent comprises deleting the first partial intent and the second partial intent that are the same as each other, and for which the first partial intent to which the first separator is assigned is the same as the second partial intent to which the second separator is assigned.

16. The method of claim 14, wherein the separating of the first intent and the second intent into the partial intent units comprises:
assigning a third separator to an entity among the first partial intents; and
assigning a fourth separator to the entity included in the second intent, wherein the fourth separator points to the entity included in the second intent that negates the entity included in the first partial intents to which the third separator was assigned.

17. The method of claim 16, wherein the generating of the final intent comprises deleting the entities that are the same as each other, and for which the entity to which the third separator is assigned is the same as the entity to which the fourth separator is assigned.

18. The method of claim 11, wherein the generating of the final intent further comprises arranging the first intent and the second intent in a reverse order of utterances.

19. The method of claim 18, wherein the generating of the final intent further comprises deleting actions other than a most preceding action among the partial intents.

20. The method of claim 19, wherein the generating of the final intent further comprises deleting partial intents that match the deleted partial intents, from among the partial intents.
